(19) United States
(12) Patent Application Publication
(10) Pub. No.: US 2025/0145879 A1
(43) Pub. Date: May 8, 2025

(54) Method of Detecting Flow Assurance Using a Tagged Asphaltene Inhibitor

(71) Applicant: Baker Hughes Oilfield Operations LLC, Houston, TX (US)

(72) Inventors: Naima Bestaoui-Spurr, The Woodlands, TX (US); Frances H. DeBenedictis, Spring, TX (US); Sumit Bhaduri, The Woodlands, TX (US)

(73) Assignee: Baker Hughes Oilfield Operations LLC, Houston, TX (US)

(21) Appl. No.: 18/387,939

(22) Filed: Nov. 8, 2023

(51) Int. Cl. C09K 8/524

(52) U.S. Cl. CPC C09K 8/524

(57) ABSTRACT

Reservoir monitoring of a producing well consists of use of a tagged asphaltene inhibitor to determine deposition of asphaltene in the well. A renewable amount of tagged asphaltene inhibitor may be introduced into the well once the amount of tagged inhibitor in the well approaches a pre-determined minimum inhibitory concentration of the tagged asphaltene inhibitor.

### FIELD

The disclosure relates to a method of maintaining the requisite amount of asphaltene inhibitor in a producing well by monitoring the amount of tagged asphaltene inhibitor released during production of hydrocarbons from the well. The method may be used to assist operators to detect flow assurance and to provide preventative action which minimizes the risks of production loss. Further, monitoring a treatment operation using the tagged asphaltene inhibitors ensures well performance is not hindered.

### BACKGROUND

Crude oil extracted from subterranean hydrocarbon reservoirs typically contain asphaltenes. Asphaltenes are generally stable in bulk oil at relatively high pressures. As reservoir pressures decrease, asphaltenes tend to precipitate. Asphaltene precipitates adversely affect the production of crude oil by causing formation damage. For instance, in some instances, asphaltene deposits form in the pores of the subterranean matrix curtailing production of hydrocarbons from the plugged pores. Asphaltene deposits further block production by coating boreholes and solidifying in downhole equipment. Asphaltene deposits are further known to cause operational and safety issues during extraction of oil which may cause failure of critical safety valves. In other instances, asphaltene deposits may negatively impact the viscoelasticity of produced crude oil. Well remediation including the repair of damaged equipment is costly and generally requires shutdown of the well.

Asphaltene inhibitors offer a means to control deposition of asphaltenes. Such inhibitors are traditionally injected into the well to remove, reduce or substantially prevent precipitation of asphaltene deposits in the formation, pipelines and tubulars. For instance, U.S. Pat. Nos. 7,493,955; 9,010,430; 9,029,300; and as well as U.S. Patent Publication No. 2021/0340432 A1 disclose the use of composites for the slow release of asphaltene inhibitors. Use of asphaltene inhibitors has been met with varying levels of success as it is often difficult to determine how much, if any, of such inhibitors are within the reservoir during prolonged treatment of the well.

The gathering and analysis of information from reservoirs during production is typically referred to as Reservoir Monitoring. Such monitoring may be used to predict flow assurance of produced fluids within the reservoir. To date, no effective method is known for monitoring asphaltene inhibitors within a well during production by Reservoir Monitoring. Such methods are needed to enhance recovery efforts and to avoid the necessity of costly well remediation.

### SUMMARY

In an embodiment, a method of monitoring the level of asphaltene inhibitor needed to inhibit or prevent deposition of asphaltene in a producing well is provided. A minimum inhibitory concentration (MIC) of P-tagged asphaltene inhibitor required to inhibit deposition of asphaltenes in a sample of fluid recovered from the producing well is first determined. The P-tagged asphaltene inhibitor consists of an asphaltene inhibitor covalently bonded to a phosphorus containing taggant. A pre-determined quantitative amount of the P-tagged asphaltene inhibitor is then introduced into the well; the pre-determined amount being in excess of the MIC. After the start of the treatment operation, an aliquot of fluid is removed from the well and the concentration of the P-tagged asphaltene inhibitor in the aliquot is determined. The concentration of the P-tagged asphaltene inhibitor in the aliquot is compared to the MIC. Additional P-tagged asphaltene inhibitor may then be introduced into the producing well once the concentration of P-tagged asphaltene inhibitor in the aliquot is from about 50 to about 175 percent of the MIC.

In another embodiment, a method of maintaining a requisite amount of asphaltene inhibitor in a producing well during production of hydrocarbons from the well is provided. A minimum inhibitory concentration (MIC) of tagged asphaltene inhibitor required to inhibit deposition of asphaltenes in a sample of fluid recovered from the producing well is first determined. An amount of the tagged asphaltene inhibitor is then introduced into the producing well. The amount of the tagged asphaltene inhibitor introduced into the producing well is capable of inhibiting deposition of asphaltene deposits in the well. An aliquot of fluid is later removed from the producing well and the concentration of tagged asphaltene inhibitor in the aliquot is then determined. The concentration of tagged asphaltene inhibitor in the aliquot is then compared to the MIC. Additional tagged asphaltene inhibitor may then be introduced into the producing well once the concentration of tagged asphaltene inhibitor in the aliquot is from about 50 to about 175 percent of the MIC.

In another embodiment, a method of minimizing asphaltene deposition in a producing well is provided. A minimum inhibitory concentration (MIC) of tagged asphaltene inhibitor required to inhibit deposition of asphaltenes in a sample of fluid recovered from the producing well is first determined. A quantity of the tagged asphaltene inhibitor is then introduced into the producing well, the tagged asphaltene inhibitor being capable of inhibiting the deposition of asphaltene deposits in the producing well. The amount of tagged asphaltene inhibitor released in crude oil from the producing well is monitored by determining the concentration of the tagged asphaltene inhibitor in an aliquot of fluid removed from the producing well. The concentration of tagged asphaltene inhibitor is then compared to the MIC. Asphaltene deposition in the producing well is minimized by introducing a renewed amount of tagged asphaltene inhibitor into the producing well once the concentration of tagged asphaltene inhibitor in the aliquot is from about 50 to about 175 percent of the MIC.

### DRAWINGS

FIGURE demonstrates performance in asphaltene deposition between P-tagged asphaltene inhibitors versus samples not containing P-tagged asphaltene inhibitors.

### DETAILED DESCRIPTION

Characteristics and advantages of the present disclosure and additional features and benefits will be readily apparent to those skilled in the art upon consideration of the following detailed description of exemplary embodiments of the present disclosure and referring to the accompanying FIGURE. It should be understood that the description herein and appended drawing, being of exemplary embodiments, is not intended to limit the claims of this patent or any patent or patent application claiming priority hereto. On the contrary, the intention is to cover all modifications, equivalents and alternatives falling within the spirit and scope of the claims.

As used herein and throughout various portions (and headings) of this patent application, the terms “disclosure”, “present disclosure” and variations thereof are not intended to mean every possible embodiment encompassed by this disclosure or any particular claim(s). Thus, the subject matter of each such reference should not be considered as necessary for, or part of, every embodiment hereof or of any particular claim(s) merely because of such reference.

Certain terms are used herein and in the appended claims to refer to particular components. As one skilled in the art will appreciate, different persons may refer to a component by different names. This document does not intend to distinguish between components that differ in name but not function.

Also, the terms “including” and “comprising” are used herein and in the appended claims in an open-ended fashion, and thus should be interpreted to mean including, but not limited to.

Further, reference herein and in the appended claims to components and aspects in a singular tense does not necessarily limit the present disclosure or appended claims to only one such component or aspect, but should be interpreted generally to mean one or more, as may be suitable and desirable in each particular instance.

The use of the terms “a” and “an” and “the” and similar references in the context of describing the invention (especially in the context of the following claims) are to be construed to cover both the singular and the plural, unless otherwise indicated herein or clearly contradicted by context. Further, the suffix “(s)” as used herein is intended to include both the singular and the plural of the term that it modifies, thereby including at least one of that term.

All ranges disclosed herein are inclusive of the endpoints. A numerical range having a lower endpoint and an upper endpoint shall further encompass any number and any range falling between the lower endpoint and the upper endpoint. For example, every range of values (in the form “from a to b” or “from about a to about b” and any similar expressions, where “a” and “b” represent numerical values of degree or measurement is to be understood to set forth every number and range encompassed within the broader range of values and inclusive of the endpoints.

All references are incorporated herein by reference.

The methodology described herein relates to reservoir monitoring of asphaltene deposits in a producing well using a tagged asphaltene inhibitor. Asphaltene deposits are inhibited, prevented or controlled by use of the tagged asphaltene inhibitor in the producing well. The methodology includes monitoring the level of asphaltene inhibitor to inhibit or prevent deposition of asphaltenes throughout a treatment operation. It offers a means of maintaining a requisite amount of asphaltene inhibitor present in a producing well throughout a treatment operation.

During treatment of the well, an aliquot of fluid may be removed and the concentration of tagged asphaltene inhibitor in the aliquot compared against a previously determined minimum inhibitory concentration (MIC) of the tagged asphaltene inhibitor. Once the concentration of tagged asphaltene inhibitor in a removed aliquot is less than the MIC, then the risk of asphaltene deposition increases dramatically. Based on the comparison, a decision may be made as to if a renewable amount of tagged asphaltene inhibitor should be added to the producing well. For example, if the concentration of the asphaltene taggant in the removed aliquot is less than or substantially the same as the MIC, then a renewed supply of tagged asphaltene inhibitor may be added to the well.

In a first stage, a sample of fluid may be recovered from the well to be treated. In a preferred embodiment, the fluid sample is removed from the well prior to the start of treatment of the well. The minimum concentration of tagged asphaltene inhibitor (MIC) required to inhibit asphaltene deposition in the sample is determined.

In an embodiment, the time of onset of asphaltene deposition in one sample of fluid removed from the well may be determined using the same temperatures and pressures to which the well is to be subjected or possibly at ambient pressure and temperature. A second fluid sample is then subjected to the same temperature and pressure and the concentration of tagged asphaltene inhibitor needed to inhibit asphaltene deposition at the onset time is then determined. This latter concentration is the MIC, i.e., the minimum amount of asphaltene inhibitor which must be added to the second fluid to inhibit the onset of asphaltene deposition.

After the MIC is determined, a well treatment operation may begin and the tagged asphaltene inhibitor may be introduced into the well. The amount of tagged asphaltene inhibitor introduced may be pre-determined; the amount is in excess of the MIC.

After a desired time of operation has occurred, an aliquot of sample may be removed from the producing well and the concentration of the tagged asphaltene inhibitor in the aliquot determined. The concentration of the tagged asphaltene inhibitor in the aliquot is compared to the MIC. A renewable or additional amount of tagged asphaltene inhibitor may be then added to the producing well depending on the results of the comparison. For instance, an additional aliquot may be added to the producing well when the concentration of the tagged asphaltene inhibitor in the aliquot is 1.75 times the MIC (175 percent of the MIC), or 1.5 times the MIC (150 percent of the MIC), or 1.25 times the MIC (125 percent of the MIC). In an embodiment, renewal tagged asphaltene inhibitor may be added when the amount of tagged asphaltene inhibitor is 50% or more of the MIC, typically 80% or more of the MIC or 90% of the MIC. In another embodiment, renewal tagged asphaltene inhibitor may be added when the concentration of the tagged asphaltene inhibitor in the aliquot is substantially equivalent to the MIC. (In a preferred embodiment, the phrase “substantially equivalent” shall refer to the amount of tagged asphaltene inhibitor in the aliquot being plus or minus 20 percent of the MIC, or plus or minus 10 percent of the MIC, or plus or minus 5 percent of the MIC as well as plus or minus 1 percent of the MIC.)

Use of the tagged asphaltene inhibitor provides the operator a means to inhibit or prevent asphaltene precipitation within the producing well and thus to minimize the risks normally encountered by asphaltene precipitation.

In an embodiment, renewable tagged asphaltene inhibitor may be added to the producing well to refreshen the amount of tagged asphaltene inhibitor lost during the treatment process. The amount of tagged asphaltene inhibitor lost during the treatment process may be determined by comparing the percentile amount of tagged asphaltene inhibitor in a collected fluid sample versus the amount of tagged asphaltene inhibitor introduced into the well or formation prior to the start of treatment.

The method described may be conducted in repetitive steps. For instance, after a renewable supply of tagged asphaltene inhibitor has been replenished, another aliquot may be obtained from the producing well, the concentration of the tagged asphaltene inhibitor in the retrieved aliquot may be determined and compared to the MIC. Additional tagged asphaltene inhibitor may then be introduced into the well to maintain the requisite level of tagged asphaltene inhibitor. The process may be repeated throughout the treatment of the well.

In an embodiment, an operator or technician may use some or all of the generated data to determine whether asphaltene inhibitors are being applied in a treatment operation in sufficient concentration and/or frequency. Where the tagged inhibitor is applied in a batch treatment, the data generated may be used to adjust the future concentration of tagged asphaltene inhibitor in a subsequent batch treatment. For instance, a tagged asphaltene inhibitor, such as a maleic anhydride copolymer bonded with a detectable (tagged) phosphorus moiety may be initially pumped into the well or formation, a fluid sample collected during the treatment operation, and the concentration of the tagged inhibitor in the collected fluid detected using an inductively coupled plasma optical emission spectrometry. Based on the concentration, the end user may opt to increase the concentration of tagged asphaltene inhibitor being pumped into the well or formation in a subsequent batch.

Further, the data analysis may be used by the operator or technician to determine the amount of tagged asphaltene inhibitor needed to replenish the amount of tagged asphaltene inhibitor consumed during the treatment operation. Monitoring the amount or concentration of tagged asphaltene inhibitor in the well or formation provides the operator the optimal time for replenishment. The renewed amount of tagged asphaltene inhibitor may then be pumped into the well or formation to attain the desired percentile of tagged asphaltene inhibitor in the treatment fluid in subsequent stages. The effective amount of asphaltene inhibitor which needs to be pumped into the well to prevent asphaltene precipitation in a well treatment operation may also be determined using the tagged asphaltene inhibitor as described. As such, impairment to the formation as well as impairment to equipment within the well may be eliminated or markedly decreased.

The treatment operation in which the tagged asphaltene inhibitor is introduced may be any suitable subterranean operations and may include, but are not limited to, preflush treatments, after flush treatments, drilling operations, hydraulic fracturing treatments, sand control treatments (e.g., gravel packing), acidizing treatments (e.g., matrix acidizing or fracture acidizing), “frac-pack” treatments, well bore clean-out treatments.

In a preferred embodiment, the tagged asphaltene inhibitor is pumped into the well as a component of a fracturing fluid. The fluid may be pumped under pressure to create or enlarge a fracture. Further, the fluid may be pumped into a well wherein fractures have already been created or enhanced in the formation. The composite may be transported into the fracture. The tagged asphaltene inhibitor is capable of withstanding elevated in-situ pressures.

In a particular embodiment, the asphaltene inhibitor may be used in a stimulation operation to monitor the amount of asphaltene inhibitor in a well during such treatment of the well or formation. In such cases, the fluid containing the tagged asphaltene inhibitor may also contain a proppant.

The tagged asphaltene inhibitor is preferably introduced into the well in a carrier fluid. The carrier fluid may be any conventional fluid used in a well treatment operation, typically a base fluid of water and/or oil. The base fluid may be a component of a drilling fluid, spacer fluid, completion fluid, fracturing fluid, preflush fluid, after flush fluid, sand control fluid, acidizing fluid, work-over fluid, etc.

The tagged inhibitors generally comprise an asphaltene inhibitor bonded with a detectable element or functional group of a taggant. The taggant may be covalently attached to the asphaltene inhibitor. Since the asphaltene inhibitor and taggant are linked to each other, the taggant and inhibitor are released into produced fluids at the same time.

Typically, the amount of taggant in the tagged asphaltene inhibitor is from about 0.01 to about 50, more typically from about 1 to about 30, and most typically from about 1 to about 15 percent, of the total weight of the tagged asphaltene inhibitor.

In a preferred embodiment, the taggant is a P-taggant and may include detectable phosphorus moieties include phosphoesters, phosphates, phosphonates, phosphate esters and organo-phosphorous compounds.

In addition to a phosphorus taggant, the taggant may be a dye (such as phenoxazone dyes, fluorescein, pyridinium betaines dyes, solvatochromatic dyes, Oregon Green, Cascade Blue, Lucifer yellow, Auramine O, tetramethylrhodamine, pysranine, sulforhodamines, hydroxycoumarins; polysulfonated pyrenes; cyanines, hydroxylamines, netural red, acridine orange), a gas (such as helium and carbon dioxide); acid (such as picric acid and salicylic acid) or a salt thereof; an ionizable compound (such as those which provide ammonium, boron, chromate, etc., ions); and radioactive material (such as krypton-85); substantially non-radioactive metals, substantially non-radioactive metal oxides, substantially non-radioactive metal sulfates, substantially non-radioactive metal carbonates, substantially non-radioactive metal phosphates, substantially non-radioactive metal salts of organic acids, phosphorescent pigments, fluorescent pigments, photoluminescent pigments, oil soluble dyes, oil dispersible dyes and oil dispersible pigments; isotopes; genetically or biologically coded materials such as antibodies/antigens; microorganisms; minerals; and high molecular weight synthetic and natural compounds and polymers (such as oligonucleotides, perfluorinated hydrocarbons like perfluoro butane, perfluoro methyl cyclopentane and perfluoro methyl cyclohexane); isotope; genetically or biologically coded materials; a microorganism; mineral; and a high molecular weight synthetic and natural compound and a polymer (such as oligonucleotides, perfluorinated hydrocarbons like perfluoro butane, perfluoro methyl cyclopentane and perfluoro methyl cyclohexane). In an embodiment, the phosphorescent, fluorescent, or photoluminescent pigments may be prepared from materials well known to those skilled in the art including but not limited to alkaline earth aluminates activated by rare earth ions, zinc sulfide phosphors, aluminate phosphors, zinc silicate phosphors, zinc sulfide cadmium phosphors, strontium sulfide phosphors, calcium tungstate phosphors and calcium sulfide phosphors.

In an embodiment, the taggant may be or include a fluorophore, i.e., a chemical that emits light at a certain wavelength of light. For instance, the chemical tag may emit light at wavelengths ranging from about 180 independently to about 600, or from about 240 independently to about 350.

Any technique known in the art for detecting taggants defined herein may be used. Suitable techniques include, but are not limited to, inductively coupled plasma optical emission spectrometry (ICP-OES) or inductively coupled plasma atomic emission spectroscopy (ICP-AES), liquid or gas chromatography (e.g., HPLC), mass spectroscopy, or any combination thereof as well as visual inspection, chemical analysis, standard spectroscopy methods such as infrared, ultraviolet and mass spectroscopy, spectrophotometric methods, chromatography (including liquid chromatography), ultraviolet light, fluorescence spectroscopy, electrochemical detection, infrared, radioactive analysis, x-ray analysis, PCR techniques combined with sequential analysis, electron capture detection or optical fibers.

The asphaltene inhibitor may be a solid or liquid. In an embodiment, where the asphaltene inhibitor is a solid, it can be dissolved in a suitable solvent, thus making it a liquid. The asphaltene inhibitor is preferably water soluble, hydrocarbon soluble or both water and hydrocarbon soluble.

Exemplary asphaltene inhibitors include, but not limited to, fatty ester homopolymers and copolymers (such as fatty esters of acrylic and methacrylic acid polymers and copolymers), sorbitan monooleate, basic iron salts of organic acids, mixtures of iron hydroxide and a basic calcium soap, basic and oil-soluble magnesium salts of sulfonic acids, succinimides, carbonyl manganese compounds and/or a neutral or basic alkali metal salt or alkaline earth metal salt of an organic acid component, as well as alkoxylated fatty amines and fatty amine derivatives, optionally in combination with an organic metal salt as well as maleic anhydride copolymers.

The tagged asphaltene inhibitors may be synthesized by conventional methods known in the art. A particularly preferred tagged asphaltene inhibitor is a phosphorus-tagged asphaltene inhibitor.

A common method is the reaction of the asphaltene inhibitor with phosphorus pentoxide. For instance, an alpha-olefin/maleic anhydride copolymer may be reacted with phosphorus pentoxide to yield an alpha-olefin/maleic anhydride copolymer tagged with a phosphorus ester according to the following synthesis pathway:

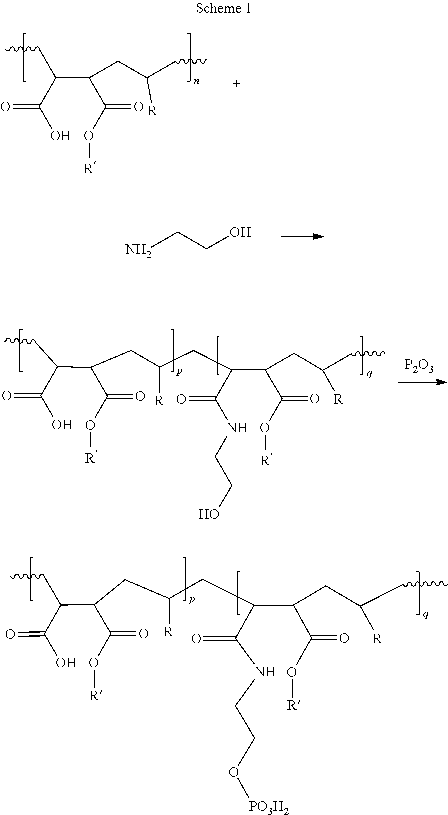

In an embodiment, the tagged asphaltene inhibitor may be immobilized onto a support or incorporated into the pores of a porous or high surface area to form a composite. The composite containing the tagged asphaltene inhibitor and support may be one wherein the tagged inhibitor is adsorbed onto an adsorbent substrate, such as a water-insoluble, oil-insoluble or both water and oil-insoluble adsorbent. A portion of the tagged asphaltene inhibitor may further be absorbed into interstitial spaces of the support. The adsorption of the tagged asphaltene inhibitor onto the solid adsorbent limits the availability of free asphaltene inhibitor in hydrocarbon. In addition, the tagged asphaltene inhibitor immobilized onto the support has limited solubility in water. Generally, the amount of tagged asphaltene inhibitor in the composite is from about 0.05 to about 70, in some cases from about 0.05 to 50 weight percent, preferably from about 0.05 to about 40 weight percent, more preferably from about 0.05 to about 20 and in some cases from about 0.1 to about 15 weight percent, and in other cases from about 0.1 to about 10 weight percent, based on the total weight of the composite.

Where the support is a water-insoluble adsorbent, it may be of various kinds of commercially available high surface area materials having the affinity to adsorb the desired asphaltene inhibitor. In an embodiment, the surface area of the adsorbent of the composite may be between from about 0.5 m²/g to about 1,000 m²/g and more typically from about 0.5 to about 700, in some instances from about 0.5 to about 110 m²/g and in other instances from about 0.5 to about 60 m²/g.

The adsorbent may be any of various kinds of commercially available high surface area materials onto which the asphaltene inhibitor may be adsorbed.

Suitable adsorbents include finely divided minerals, fibers, ground almond shells, ground walnut shells, and ground coconut shells. Further suitable water-insoluble adsorbents include activated carbon and/or coals, silica particulates, precipitated silicas, silica (quartz sand), alumina, silica-alumina such as silica gel, mica, silicate, e.g., orthosilicates or metasilicates, calcium silicate, sand (e.g., 20-40 mesh), ceramics, bauxite, kaolin, talc, zirconia, boron and glass, including glass microspheres or beads, fly ash, zeolites, diatomaceous earth, ground walnut shells, fuller's earth and organic synthetic high molecular weight water-insoluble adsorbents. Particularly preferred are alumina, diatomaceous earth and ground walnut shells. Alumina is particularly preferred in those instances where it is desired for the coated composite to withstand high compressive stresses, including up to 20,000 psi.

Further useful as adsorbents are clays such as natural clays, preferably those having a relatively large negatively charged surface, and a much smaller surface that is positively charged. Other examples of such high surface area materials include such clays as bentonite, illite, montmorillonite and synthetic clays.

The weight ratio of asphaltene inhibitor to water-insoluble adsorbent may be between from about 9.8:0.2 to about 0.2:9.8, often from about 9:1 to about 1:9.

The composite may be prepared by adding the tagged asphaltene inhibitor to the adsorbent and mixing until the tagged asphaltene inhibitor is readily adsorbed and/or absorbed. The product may then be dried at elevated temperatures (for instance, from about 220° F. to about 250° F.) until the percent moisture of the resulting product is less than 3%. Suitable methods of preparing asphaltene inhibitors adsorbed and/or absorbed onto a support, such as a water-insoluble adsorbent, are disclosed in U.S. Pat. Nos. 7,491,682; 7,493,955; 7,977,283; and 8,664,168, all of which are herein incorporated by reference.

Suitable composites also include those composed of a porous particulate as support onto which or within one or more tagged asphaltene inhibitors are immobilized. Typically, the particle size of the porous particulate is between about 0.3 mm to about 5 mm, preferably between from about 0.4 to about 2 mm. The porosity and permeability of the porous particulate is such that the tagged asphaltene inhibitor may be absorbed into the pores of the porous particulate material. Generally, the amount of tagged asphaltene inhibitor in such composites is from about 0.05 to about 70 (preferably from about 0.1 to about 2) weight percent based upon the total weight of the composite. Since the tagged asphaltene inhibitor is employed in the composites are capable of being absorbed into the interstitial spaces of the porous particulates, they may be slowly released from the porous particulates into produced fluids after a fissure is created in the coating. Upon release from the porous particulate, the tagged asphaltene inhibitor may then flow from the inside of the composite into the environs through the fissure.

Suitable as porous particulates are those particulates set forth in U.S. Pat. Nos. 5,964,291 and 7,598,209, herein incorporated by reference. For instance, the porous particulate of the composite may be any naturally occurring or manufactured or engineered porous ceramic particulate, as well as any organic polymeric material, that has an inherent and/or induced porosity. Suitable as inorganic ceramic materials are alumina, magnetic glass, titanium oxide, zirconium oxide, ceramics, silicon carbide, aluminosilicates and other silica-based materials. Examples of non-natural porous particulate materials include, but are not limited to, porous ceramic particles, such as fired kaolinitic particles, as well as partially sintered bauxite. The porous particulates may further be porous natural ceramic materials, such as lightweight volcanic rocks, like pumice, as well as perlite and other porous “lavas” like porous (vesicular) Hawaiian Basalt, porous Virginia Diabase and Utah Rhyolite. Such naturally occurring materials may be strengthened or hardened by use of modifying agents to increase the ability of the naturally occurring material to resist deformation. A starch binder may be employed. Suitable polymeric materials for use as the porous particulate in such applications include thermosetting resins, such as polystyrene, a styrene-divinylbenzene copolymer, a polyacrylate, a polyalkylacrylate, a polyacrylate ester, a polyalkyl acrylate ester, a modified starch, a polyepoxide, a polyurethane, a polyisocyanate, a phenol formaldehyde resin, a furan resin, or a melamine formaldehyde resin.

The composite may further be composed of a tagged asphaltene inhibitor and a calcined metal oxide, such as those disclosed in U.S. Pat. No. 9,029,300. Such composites include those where the tagged asphaltene inhibitor is adsorbed onto a nano-sized calcined porous substrate of high surface area. The porosity and permeability of the calcined porous substrate may be such that the tagged asphaltene inhibitor may also be absorbed into the interstitial spaces of the porous substrate. In an embodiment, the surface area of the calcined porous substrate of such composites may be between from about 1 m²/g to about 10 m²/g, in some cases between from about 1.5 m²/g to about 4 m²/g, the diameter of the calcined porous substrate may be between from about 0.1 to about 3 mm, in some cases between from about 150 to about 1780 micrometers, and the pore volume of the calcined porous substrate may be between from about 0.01 to about 0.10 g/cc. The porous metal oxide is typically spherical and insoluble in well fluids under subterranean conditions, such as at temperatures less than about 250° C.

The porous substrate may be a metal oxide, such as alumina, zirconium oxide and titanium oxide. The support of the coated composite is typically a calcined metal oxide of high surface area such as alumina, zirconium oxide, aluminosilicate and titanium oxide. The substrate may further include silica. Typically, the porous substrate is alumina. Typically, the bulk density of the composite is between about 75 to about 150 lb/ft³. Methods for making metal oxide adsorbent are further disclosed in U.S. Pat. Nos. 9,029,300 B2 and 10,822,536 B2.

At least a portion of the surface of the tagged asphaltene inhibitors as well as composites containing the tagged asphaltene inhibitors may be coated with a resin, plastic, sealant or cement. In such instances, it is preferred that at least 50% and usually at least 75% of the total surface area of the inhibitor or composite is coated. Suitable coatings include organic polymers such as thermoplastic and thermosetting resins like polyethylene, acrylonitrile-butadiene styrene, polystyrene, polyvinyl chloride, fluoroplastics, polysulfide, polypropylene, styrene acrylonitrile, nylon, and phenylene oxide, epoxy resins, phenolic resins, melamine formaldehyde resins, polyester resins, polyurethanes, epoxy-modified phenolic resin, polyurethanes, polycarbodiimides, polyamides, polyamide imides, furan resins, melamine formaldehyde resins and derivatives and combinations thereof. Inorganic coatings may include inorganic compounds such as those containing metal like zirconium or zinc, such as zirconium silicate and zinc silicate.

The coating preferably surrounds or envelopes the entire surface of the tagged asphaltene inhibitors or composites containing the tagged asphaltene inhibitors though the coating may cover only a portion of the surface. The coating not only shields the asphaltene inhibitor as well as composite containing the asphaltene inhibitor from harsh environ conditions, but it also delays release into the environs until the coating develops cracks or fissures. Over time, the pressure within the well or formation creates fissures (or cracks) in the coating. The asphaltene inhibitor is gradually released into the environs through the fissure(s). Where the asphaltene inhibitor is a member of a composite, the asphaltene inhibitor disassociates from the support and is then released into the environs through the fissure(s). The coating prolongs the time of release of the asphaltene inhibitor into the well or formation (compared to a substantially similar tagged asphaltene inhibitor which is uncoated). In some instances, the tagged asphaltene inhibitor may not be released into the environs after a certain period of time, and possibly several months or more after being introduced into the well or formation.

Coated tagged asphaltene inhibitors as well as composites containing the tagged asphaltene inhibitors may be of particular value in those treatment operations where the formation is subjected to high compressive forces, such as in stimulation operations like hydraulic fracturing, slickwater fracturing, acid fracturing, frac packing and gravel packing.

The treatment operation may consist of placing the tagged asphaltene inhibitor in or near a subterranean formation, wellbore, umbilical equipment, pipeline, or other equipment and locations where asphaltene inhibition is desired.

### EXAMPLES

The following examples are illustrative of some of the embodiments of the present invention.

Example 1. This example demonstrates very low concentrations of inhibitor in oil. A sample void of asphaltene inhibitor (“AI”) (“Blank”), a tagged asphaltene inhibitor and one coated tagged inhibitor sample (“PF”) were placed into a 180° F. water bath for 24 hours. After 24 hours, asphaltene deposition testing was conducted on a sample of each of the samples. The results are shown in Table I below:

TABLE I

| | | | | Performance |
|---|---|---|---|---|
| | | P, | | (% asphaltene |
| | Sample | ppm | Comments | inhibition) |
| A | Blank | 0 | No inhibitor | 0% |
| B | 0.5 g coated p-tagged | 1.332 | PF added to oil | 5% |
| | inhibitor in 100 mL | | 100 mL then | |
| | oil | | extracted, ~40 ppm | |
| C | 0.05 g tagged | 1.672 | AI added to oil | 3% |
| | inhibitor in 50 mL | | 50 mL then | |
| | oil | | extracted, ~50 ppm | |

As illustrated in Table I:

All of the asphaltenes precipitated out of Sample A (containing no asphaltene inhibitor), therefore no inhibition was seen with Sample A;

Sample B contained 0.5 g coated composite of p-tagged inhibitor after delay mechanism was triggered in 100 mL; Sample B being placed into the 180° F. water bath for 24 hours. The asphaltene deposition test conducted after the 24 hours rendered less than 5% performance;

Sample C was prepared with 0.05 g of commercial tagged inhibitor in 50 mL untreated oil. The asphaltene deposition test conducted after the sample was placed in the 180° F. water for 24 hours showed 3% performance.

These performance values are to be expected because normal treatment loadings are often 250 ppm, 500 ppm and 1000 ppm. The low treatment loadings were to determine the lower range of detection.

Example 2. Two different concentrations of tagged liquid inhibitors were prepared in crude oil and analyzed by ICP for P concentration. The results showed concentrations of 0.258 ppm P and 1.672 ppm P, respectively. These results were confirmation of the ppm loading.

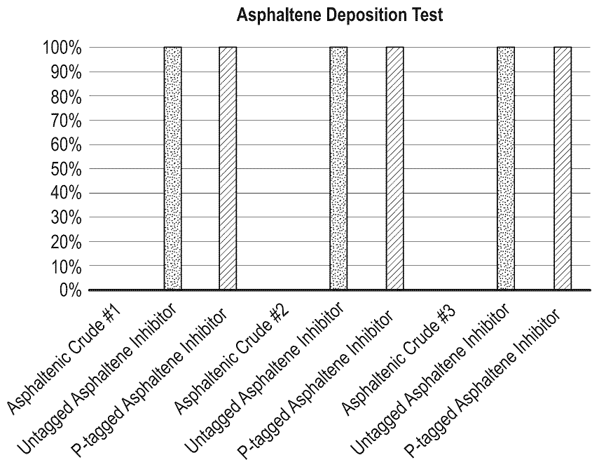

Example 3. Performance of the P-tagged liquid inhibitor was compared to the untagged inhibitor in three different asphaltenic crude samples. The asphaltene deposition test was conducted by adding 12 mL hexane to a graduated conical tube. 200 μL of the untreated or treated crude oil was added to hexane, capped and gently mixed. A timer was then started and asphaltene deposition was observed. FIG. 1 shows the performance comparison. The baseline asphaltenic crude samples precipitated all asphaltenes (hence 0% inhibition). Both the untagged and P-tagged asphaltene inhibitors had 100% inhibition.

The methods that may be described above or claimed herein and any other methods which may fall within the scope of the appended claims can be performed in any desired suitable order and are not necessarily limited to any sequence described herein or as may be listed in the appended claims. Further, the methods of the present disclosure do not necessarily require use of the particular embodiments shown and described herein, but are equally applicable with any other suitable structure, form and configuration of components.

Embodiment 1. A method of monitoring the level of asphaltene inhibitor needed to inhibit or prevent deposition of asphaltene in a producing well, the method comprising (a) determining a minimum inhibitory concentration (MIC) of P-tagged asphaltene inhibitor required to inhibit deposition of asphaltenes in a sample of fluid recovered from the producing well, the P-tagged asphaltene inhibitor comprising an asphaltene inhibitor covalently bonded to a phosphorus containing taggant; (b) introducing into the producing well a pre-determined quantitative amount in excess of the MIC of the P-tagged asphaltene inhibitor; (c) determining the concentration of the P-tagged asphaltene inhibitor in an aliquot of fluid removed from the producing well; (d) comparing the concentration of the P-tagged asphaltene inhibitor in the aliquot to the MIC; and (e) introducing additional P-tagged asphaltene inhibitor into the producing well once the concentration of P-tagged asphaltene inhibitor in the aliquot is less than or equal to 175% of the MIC.

Embodiment 2. The method of embodiment 1, further comprising repeating steps (c), (d) and (e).

Embodiment 3. The method of embodiment 2, wherein steps (c), (d) and (e) are successively repeated during the life of the producing well.

Embodiment 4. The method of any of embodiments 1 to 3, wherein the additional P-tagged asphaltene inhibitor of (e) is introduced into the producing well after the concentration of P-tagged asphaltene inhibitor in the aliquot is less than or equal to 150 percent of the MIC.

Embodiment 5. The method of embodiment 4, wherein the additional P-tagged asphaltene inhibitor of (e) is introduced into the producing well after the concentration of P-tagged asphaltene inhibitor in the aliquot is less than or equal to 125 percent of the MIC.

Embodiment 6. The method of any of embodiments 1 to 3, wherein the additional P-tagged asphaltene inhibitor of (e) is introduced into the producing well after the concentration of P-tagged asphaltene inhibitor in the aliquot is substantially equivalent to the MIC.

Embodiment 7. The method of any of embodiments 1 to 3, wherein the additional P-tagged asphaltene inhibitor of (e) is introduced into the producing well after the concentration of P-tagged asphaltene inhibitor in the aliquot is plus or minus 20 percent of the MIC.

Embodiment 8. The method of embodiment 7, wherein the additional P-tagged asphaltene inhibitor of (e) is introduced into the producing well after the concentration of P-tagged asphaltene inhibitor in the aliquot is plus or minus 10 percent of the MIC.

Embodiment 9. The method of embodiment 8, wherein the additional P-tagged asphaltene inhibitor of (e) is introduced into the producing well after the concentration of P-tagged asphaltene inhibitor in the aliquot is plus or minus 10 percent of the MIC.

Embodiment 10. The method of embodiment 9, wherein the additional P-tagged asphaltene inhibitor of (e) is introduced into the producing well after the concentration of P-tagged asphaltene inhibitor in the aliquot is plus or minus 5 percent of the MIC.

Embodiment 11. The method of embodiment 10, wherein the additional P-tagged asphaltene inhibitor of (e) is introduced into the producing well after the concentration of P-tagged asphaltene inhibitor in the aliquot is plus or minus 1 percent of the MIC.

Embodiment 12. A method of maintaining a requisite amount of asphaltene inhibitor in a producing well during production of hydrocarbons from the well, the method comprising (a) determining a minimum inhibitory concentration (MIC) of tagged asphaltene inhibitor required to inhibit deposition of asphaltenes in a sample of fluid recovered from the producing well; (b) introducing into the producing well the tagged asphaltene inhibitor in a sufficient amount to inhibit deposition of asphaltene in the producing well, the tagged asphaltene inhibitor comprising the asphaltene inhibitor and a taggant attached thereto; (c) determining the concentration of the tagged asphaltene inhibitor in an aliquot of fluid removed from the producing well; (d) comparing the concentration of tagged asphaltene inhibitor in the aliquot to the MIC; and (e) introducing additional tagged asphaltene inhibitor into the producing well once the concentration of asphaltene inhibitor in the aliquot is less than or equal to 175% of the MIC.

Embodiment 13. The method of embodiment 12, further comprising repeating steps (c), (d) and (e).

Embodiment 14. The method of embodiment 13, wherein steps (c), (d) and (e) are successively repeated during the life of the producing well.

Embodiment 15. The method of any of embodiments 12 to 14, wherein the additional tagged asphaltene inhibitor of (e) is introduced into the producing well after the concentration of tagged asphaltene inhibitor in the aliquot is less than or equal to 150 percent of the MIC.

Embodiment 16. The method of embodiment 15, wherein the additional tagged asphaltene inhibitor of (e) is introduced into the producing well after the concentration of tagged asphaltene inhibitor in the aliquot is less than or equal to 125 percent of the MIC.

Embodiment 17. The method of any of embodiments 12 to 14, wherein the additional tagged asphaltene inhibitor of (e) is introduced into the producing well after the concentration of tagged asphaltene inhibitor in the aliquot is substantially equivalent to the MIC.

Embodiment 18. The method of any of embodiments 12 to 14, wherein the additional tagged asphaltene inhibitor of (e) is introduced into the producing well after the concentration of tagged asphaltene inhibitor in the aliquot is plus or minus 20 percent of the MIC.

Embodiment 19. The method of embodiment 18, wherein the additional tagged asphaltene inhibitor of (e) is introduced into the producing well after the concentration of tagged asphaltene inhibitor in the aliquot is plus or minus 10 percent of the MIC.

Embodiment 20. The method of embodiment 18, wherein the additional tagged asphaltene inhibitor of (e) is introduced into the producing well after the concentration of tagged asphaltene inhibitor in the aliquot is plus or minus 5 percent of the MIC.

Embodiment 21. The method of embodiment 20, wherein the additional tagged asphaltene inhibitor of (e) is introduced into the producing well after the concentration of tagged asphaltene inhibitor in the aliquot is plus or minus 1 percent of the MIC.

Embodiment 22. A method of minimizing asphaltene deposition in a producing well, the method comprising (a) determining a minimum inhibitory concentration (MIC) of tagged asphaltene inhibitor required to inhibit deposition of asphaltenes in a sample of fluid recovered from the producing well, the tagged asphaltene inhibitor comprising a taggant coupled to an asphaltene inhibitor; (b) introducing into the producing well a quantity of the tagged asphaltene inhibitor, the asphaltene inhibitor being capable of inhibiting the deposition of asphaltene deposits in the producing well; (c) monitoring an amount of tagged asphaltene inhibitor released in crude oil from a producing well by determining the concentration of the tagged asphaltene inhibitor in an aliquot of fluid removed from the producing well and comparing the concentration of the tagged asphaltene inhibitor in the aliquot to the MIC; and (e) minimizing asphaltene deposition in the producing well by introducing additional tagged asphaltene inhibitor into the producing well once the concentration of asphaltene inhibitor in the aliquot is less than or equal to 175% of the MIC.

Embodiment 23. The method of embodiment 22, further comprising repeating steps (c), (d) and (e).

Embodiment 24. The method of embodiment 23, wherein steps (c), (d) and (e) are successively repeated during the life of the producing well.

Embodiment 25. The method of any of embodiments 22 to 24, wherein the additional tagged asphaltene inhibitor of (e) is introduced into the producing well after the concentration of tagged asphaltene inhibitor in the aliquot is less than or equal to 150 percent of the MIC.

Embodiment 26. The method of embodiment 25, wherein the additional tagged asphaltene inhibitor of (e) is introduced into the producing well after the concentration of tagged asphaltene inhibitor in the aliquot is less than or equal to 125 percent of the MIC.

Embodiment 27. The method of any of embodiments 22 to 24, wherein the additional tagged asphaltene inhibitor of (e) is introduced into the producing well after the concentration of tagged asphaltene inhibitor in the aliquot is substantially equivalent to the MIC.

Embodiment 28. The method of any of embodiments 23 to 24, wherein the additional tagged asphaltene inhibitor of (e) is introduced into the producing well after the concentration of tagged asphaltene inhibitor in the aliquot is plus or minus 20 percent of the MIC.

Embodiment 29. The method of embodiment 28, wherein the additional tagged asphaltene inhibitor of (e) is introduced into the producing well after the concentration of tagged asphaltene inhibitor in the aliquot is plus or minus 10 percent of the MIC.

Embodiment 30. The method of embodiment 29, wherein the additional tagged asphaltene inhibitor of (e) is introduced into the producing well after the concentration of tagged asphaltene inhibitor in the aliquot is plus or minus 5 percent of the MIC.

Embodiment 31. The method of embodiment 30, wherein the additional tagged asphaltene inhibitor of (e) is introduced into the producing well after the concentration of tagged asphaltene inhibitor in the aliquot is plus or minus 1 percent of the MIC.

Embodiment 32. The method of any of embodiments 12 to 31, wherein the tagged asphaltene inhibitor is a P-tagged asphaltene inhibitor.

Embodiment 33. The method of any of embodiments 1 to 32, wherein the taggant is a dye, radioactive material, isotope, fluorophore, phosphorescent pigment, fluorescent pigment, photoluminescent pigment or phosphorus.

Embodiment 34. The method of any of embodiments 1 to 33, wherein a protective coating of an organic polymer or inorganic material envelops the tagged asphaltene inhibitor.

Embodiment 35. The method of any of embodiments 1 to 34, wherein the tagged asphaltene inhibitor introduced into the producing well in step (b) comprises the tagged asphaltene inhibitor immobilized onto a surface of a support or into pores of a porous support to form a composite and further wherein the tagged asphaltene inhibitor is released from the composite during treatment of the well.

Embodiment 36. The method of embodiment 35, wherein the composite is covered with a protective coating of an organic polymer or inorganic material and further wherein the tagged asphaltene inhibitor is released over time from the composite upon forming a crack or fissure in the protective coating.

Embodiment 37. The method of any of embodiments 1 to 36, wherein the amount of taggant in the tagged asphaltene inhibitor is from about 0.01 to about 50 percent of the total weight of the tagged asphaltene inhibitor.

Embodiment 38. The method of embodiment 37, wherein the amount of taggant in the tagged asphaltene inhibitor is from about 1 to about 30 percent of the total weight of the tagged asphaltene inhibitor.

What is claimed is:

1. A method of monitoring the level of asphaltene inhibitor needed to inhibit or prevent deposition of asphaltene in a producing well, the method comprising:
(a) determining a minimum inhibitory concentration (MIC) of P-tagged asphaltene inhibitor required to inhibit deposition of asphaltenes in a sample of fluid recovered from the producing well, the P-tagged asphaltene inhibitor comprising an asphaltene inhibitor covalently bonded to a phosphorus containing taggant;
(b) introducing into the producing well a pre-determined quantitative amount in excess of the MIC of the P-tagged asphaltene inhibitor;
(c) determining the concentration of the P-tagged asphaltene inhibitor in an aliquot of fluid removed from the producing well;
(d) comparing the concentration of the P-tagged asphaltene inhibitor in the aliquot to the MIC; and
(e) introducing additional P-tagged asphaltene inhibitor into the producing well once the concentration of P-tagged asphaltene inhibitor in the aliquot is less than or equal to 175% of the MIC.

2. The method of claim 1, further comprising repeating steps (c), (d) and (e).

3. The method of claim 2, wherein steps (c), (d) and (e) are successively repeated during the life of the producing well.

4. The method of claim 1, wherein the additional P-tagged asphaltene inhibitor of (e) is introduced into the producing well after the amount of P-tagged asphaltene inhibitor of (c) is less than or equal to 150 percent of the MIC.

5. A method of maintaining a requisite amount of asphaltene inhibitor in a producing well during production of hydrocarbons from the well, the method comprising:
(a) determining a minimum inhibitory concentration (MIC) of tagged asphaltene inhibitor required to inhibit deposition of asphaltenes in a sample of fluid recovered from the producing well;
(b) introducing into the producing well the tagged asphaltene inhibitor in a sufficient amount to inhibit deposition of asphaltene in the producing well, the tagged asphaltene inhibitor comprising the asphaltene inhibitor and a taggant attached thereto;
(c) determining the concentration of the tagged asphaltene inhibitor in an aliquot of fluid removed from the producing well;
(d) comparing the concentration of tagged asphaltene inhibitor in the aliquot to the MIC; and
(e) introducing additional tagged asphaltene inhibitor into the producing well once the concentration of asphaltene inhibitor in the aliquot approaches the MIC.

6. The method of claim 5, wherein the additional tagged asphaltene inhibitor is introduced into the producing well after the amount of tagged asphaltene inhibitor of (c) is less than or equal to 150 percent of times the MIC.

7. The method of claim 5, wherein the additional tagged asphaltene inhibitor is introduced into the producing well after the concentration of the tagged asphaltene inhibitor of in the aliquot of (c) is plus or minus percent 20 percent of the MIC.

8. The method of claim 5, wherein the additional tagged asphaltene inhibitor is introduced into the producing well after the amount of the tagged asphaltene inhibitor of (c) is substantially equivalent to the MIC.

9. The method of claim 5, further comprising repeating steps (c), (d) and (e).

10. The method of claim 9, wherein steps (c), (d) and (e) are successively repeated during the life of the producing well.

11. The method of claim 5, wherein the taggant is a dye, radioactive material, isotope, fluorophore, phosphorescent pigment, fluorescent pigment, photoluminescent pigment or phosphorus.

12. The method of claim 5, wherein a protective coating of an organic polymer or inorganic material envelops the tagged asphaltene inhibitor.

13. The method of claim 5, wherein the tagged asphaltene inhibitor introduced into the producing well in step (b) comprises the tagged asphaltene inhibitor immobilized onto a surface of a support or into pores of a porous support to form a composite and further wherein the tagged asphaltene inhibitor is released from the composite during treatment of the well.

14. The method claim 13, wherein the composite is covered with a protective coating of an organic polymer or inorganic material and further wherein the tagged asphaltene inhibitor is released over time from the composite upon forming a crack or fissure in the protective coating.

15. The method of claim 5, wherein the amount of taggant in the tagged asphaltene inhibitor is from about 0.01 to about 50 percent of the total weight of the tagged asphaltene inhibitor.

16. The method of claim 15, wherein the amount of taggant in the tagged asphaltene inhibitor is from about 1 to about 30 percent of the total weight of the tagged asphaltene inhibitor.

17. A method of minimizing asphaltene deposition in a producing well, the method comprising:
(a) determining a minimum inhibitory concentration (MIC) of tagged asphaltene inhibitor required to inhibit deposition of asphaltenes in a sample of fluid recovered from the producing well, the tagged asphaltene inhibitor comprising a taggant coupled to an asphaltene inhibitor;
(b) introducing into the producing well a quantity of the tagged asphaltene inhibitor, the asphaltene inhibitor being capable of inhibiting the deposition of asphaltene deposits in the producing well;
(c) monitoring an amount of tagged asphaltene inhibitor released in crude oil from a producing well by determining the concentration of the tagged asphaltene inhibitor in an aliquot of fluid removed from the producing well and comparing the concentration of the tagged asphaltene inhibitor in the aliquot to the MIC; and
(d) minimizing asphaltene deposition in the producing well by introducing additional tagged asphaltene inhibitor into the producing well once the concentration of tagged asphaltene inhibitor in the aliquot is less than or equal to 175 percent of the MIC.

18. The method of claim 17, wherein the concentration of tagged asphaltene inhibitor in the aliquot is between the MIC and 125 percent of the MIC.

19. The method of claim 17, wherein steps (c) and (d) are successively repeated during the life of the producing well.

20. The method of claim 17, wherein the taggant is a dye, radioactive material, isotope, fluorophore, phosphorescent pigment, fluorescent pigment, photoluminescent pigment or phosphorus.
